(19) United States
(12) Patent Application Publication
(10) Pub. No.: US 2009/0055326 A1
(43) Pub. Date: Feb. 26, 2009

(54) System and method for securities information service

(76) Inventors: Chu Tsung Chen, Taipei City (TW); Ching Feng Wang, Tainan City (TW)

Correspondence Address: Raymond Sun, 12420 Woodhall Way, Tustin, CA, 92782, US

(21) Appl. No.: 12/229,478

(22) Filed: Aug. 21, 2008

(30) Foreign Application Priority Data
Aug. 23, 2007 (TW) 096131173

(51) Int. Cl. G06Q 40/00; G06F 17/30

(52) U.S. Cl. 705/36 R; 705/35; 707/104.1; 707/E17.044

(57) ABSTRACT

A securities information service system, comprising: a securities information module, a transaction record module, and an information service module. The securities information module receives a plurality of securities information from at least an external source of securities information. The transaction record module receives a plurality of transaction records provided by at least an external brokerage firm. The information service module accepts at least a user option from an external user, and compiles a combined data from the plurality of securities information and transaction records according to the user option, as well as simultaneously displaying all contents of the combined data for the user. The securities information service system may simultaneously display combined data derived from different sources, and generate recommended buying/selling prices according to the combined data so as to assist users in determining a most preferred time for buying/selling securities.

### BACKGROUND OF INVENTION

1. Field of the Invention

The invention relates to a system and a method for securities information service, and particularly to a system and a method for securities information service wherein combined data from different sources are simultaneously displayed at a user terminal, and recommended buying/selling prices are generated according to the combined data so as to assist users in determining a most preferred time for buying/selling securities.

2. Description of the Prior Art

With the rapid advancement of information technologies, people's demand for access to information and communication instantly and conveniently has grown exponentially, and a variety of wireless communication devices are constantly introduced in order to meet such demands. For example, devices that include various cell phones, smart phones, stock managers, and PDAs (Personal Digital Assistants) with the function of mobile communication.

Apart from hardware such as the aforesaid wireless communication devices, a diversity of software that may be used in combination with the hardware are also constantly introduced, so as to allow users to manage financial businesses, works, entertain themselves, or obtain information instantly and conveniently at any time and anywhere. For instance, the use of wireless communication devices for carrying out electronic transactions related to securities or futures. For the wireless communication devices used for carrying out electronic transactions related to securities or futures, instantaneous remainder of the time to buy/sell securities is a crucial feature in addition to the function of electronic ordering, so that users may precisely decide a most preferred time for buying/selling securities according to a large amount of securities information.

In the conventional securities information services, when remainders are provided for users to decide when to buy/sell securities, only information from a single source is referred to; such as from instant financial news or technical indicators, while information from different sources like the basic information of companies, financial reports, personal portfolios, and stock management may only be listed in tables instead of being displayed simultaneously. In other words, only information from a single source is displayed on a screen of a user's device, and if the user wishes to refer to information from other sources, he must locate and filter out his desired information from the device by himself. From the viewpoint of displaying web pages, this method has the risk of storing all of the information in a single server, and a user's portfolios and transaction records may not be updated simultaneously, which must be inputted by the user one entry after another. Moreover, in the currently known securities information services, the comparison conditions created in regard to setting a time for buying/selling securities is limited to making comparison with only information from a single source, and may not make simultaneous comparison with information from different sources, or generate a recommended buying/selling price by referring to information from different sources. As a result, the conventional securities information services are not only unable to simultaneously provide various information required by users for buying/selling securities, but also put the burden of taking time to locate relevant information on the users, which lowers the accuracy of the remainders for buying/selling securities, and reduces the performance of such systems, hence rendering the users less satisfied with using the systems.

### SUMMARY OF INVENTION

A primary objective of the invention is to propose a system and a method for securities information service, which display a combined data derived from different sources at a user terminal, and generate a recommended buying/selling price according to the combined data in order to assist users in determining a most preferred time for buying/selling securities. Therefore, a time required by users to look up relevant information before determining when to buy/sell securities may be effectively shortened, which allows users to determine a time for buying/selling securities more accurately and efficiently.

In order to achieve the aforementioned objective, the present invention discloses a securities information service system which comprises: a securities information module, a transaction record module, and an information service module. The securities information module receives a plurality of securities information from at least an external source of securities information. The transaction record module receives a plurality of transaction records provided by at least an external brokerage firm. The information service module accepts at least a user option from an external user, and compiles a combined data from the plurality of securities information and transaction records according to the user option, as well as simultaneously displaying all contents of the combined data for the user. The securities information service system may simultaneously display combined data derived from different sources, and generate recommended buying/selling prices according to the combined data so as to assist users in determining a most preferred time for buying/selling securities.

In a preferred embodiment, the securities information may be selected from the group consisting of instant messages and securities data; the securities data includes at least one of following: technical indicators, basic information of companies, and financial reports; the transaction record at least includes: volumes of securities transactions and prices of securities transactions; while the user option at least includes: self-selected portfolios and self-selected formulated portfolios.

In a preferred embodiment, the securities information service system further comprises:

a database for storing the plurality of securities data received via the securities information module, as well as the plurality of transaction records received via the transaction record module, and for accepting a securities data inquiry from the information service module; and

a transaction record analysis module located between the information service module and the database, for accepting a transaction record inquiry from the information service module, as well as retrieving and compiling relevant information from the database according to the transaction record inquiry.

In a preferred embodiment, the information service module creates at least one comparison condition according to the combined data, in which when contents of the instant messages satisfy the at least one comparison condition, the information service module sends an alerting signal to the user. The comparison condition may be selected from the group consisting of: a suggested purchasing price, a suggested selling price, a cost-price of purchase, PE10 (Price as 10 times of Earning), PE20 (Price as 20 times of Earning), 52-week Low (a lowest price for last 52 weeks), and 52-week High (a highest price for last 52 weeks).

In a preferred embodiment, a terminal device used by the user further comprises:

a login module for assisting the user to log into the external sources of securities information and brokerage firms;

a connecting module for connecting to the sources of securities information and brokerage firms, and carrying out communications via a communication protocol supported by the sources of securities information and brokerage firms; wherein the connecting module may use at least one of following communication protocols for carrying out communications: GSM, GPRS, 3 G, DAB, and DVB; the connecting module further comprises: a TCP/IP module, a SMS (Short Message Service) module, a SPI (Serial Peripheral Interface) module, and a RS232 module;

an application interface for accepting a command from the user and executing an application according to the command; the application interface further comprises: a mean of investment, a mean of display, a mean of ordering;

a data module for storing a plurality of data received by the terminal device of the user; wherein the plurality of data includes at least one of following: instant messages, technical analysis, basic information of companies, and information of self-selected portfolios; and

a core engine for interacting with the application interface, the sources of securities information, and the brokerage firms, processing data from the connecting module, and processing commands from the application interface; the core engine further comprises: an authorization module, a maintenance module, and a data processing module.

In order to achieve the aforementioned objective, the present invention also discloses a method for securities information service, which comprises:

receiving a plurality of securities information from at least an external source of securities information;

receiving a plurality of transaction records provided by at least an external brokerage firm; and

accepting at least one user option provided by an external user, subsequently compiling a combined data from the plurality of securities information and transaction records according to the user option, as well as simultaneously displaying all contents of the combined data to the user;

### BRIEF DESCRIPTION OF THE DRAWINGS

The present invention as well as a preferred mode of use, further objectives and advantages thereof will best be understood by reference to the following detailed description of illustrative embodiments when read in conjunction with the accompanying drawings, wherein:

FIG. 1 is a schematic view that shows a push-pull structure of a system of securities information service according to a preferred embodiment of the invention.

FIG. 2 is a schematic view that shows a basic structure of a system of securities information service according to a preferred embodiment of the invention.

FIG. 3 is a schematic view that shows a structure of a system of securities information service according to a preferred embodiment of the invention.

FIG. 4 is a block view that shows devices of user terminals according to a preferred embodiment of the invention.

FIG. 5 is a flow chart that shows a method for securities information service according to a preferred embodiment of the invention.

### DETAILED DESCRIPTION OF THE PREFERRED EMBODIMENT

In the system and the method for securities information service of the invention, a combined data derived from different sources of securities information is simultaneously displayed at a user terminal, and a recommended buying/selling price is generated according to the combined data to assist users in determining a most preferred time for buying/selling securities. The system of securities information service of the invention comprises: a securities information module, a transaction record module, and an information service module. The securities information module receives securities information from external sources of securities information. The transaction record module receives transaction records provided by external brokerage firms. The information service module accepts user options from external users, and compiles a combined data from the securities information and the transaction records according to the user options, as well as simultaneously displaying all contents of the combined data for the user. Moreover, the information service module creates comparison conditions according to the user options and the combined data, when an instant message satisfies the comparison conditions; the information service module sends an alerting signal to the users, so as to shorten a time required by the users to look up relevant information before determining when to buy/sell securities, which allows the users to determine a time for buying/selling securities more accurately and efficiently.

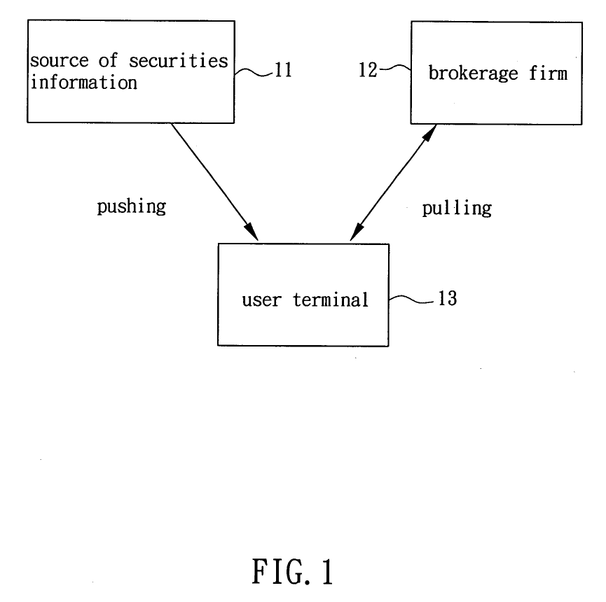

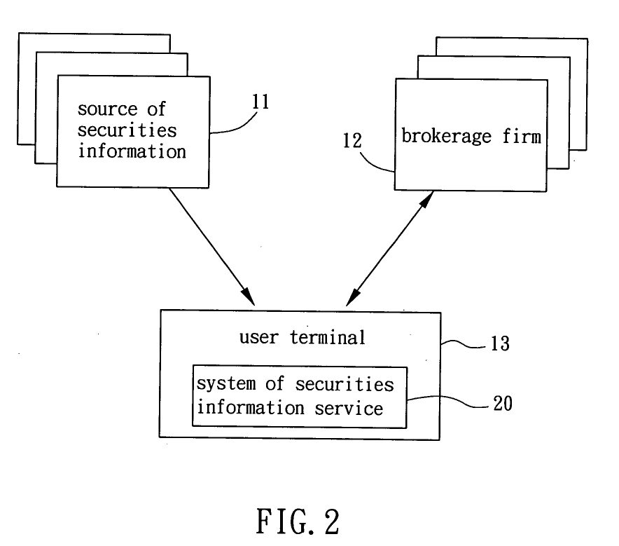

Referring to FIGS. 1 and 2, wherein FIG. 1 is a schematic view that shows a push-pull structure of a system of securities information service according to a preferred embodiment of the invention, and FIG. 2 is a schematic view that shows a basic structure of a system of securities information service according to a preferred embodiment of the invention. Basically, a user terminal 13 of a system of securities information service of the invention may receive securities information from a source of securities information 11 (i.e. pushing), and may also send an inquiry to a brokerage firm 12 and receive related transaction records (i.e. pulling). The received securities information and transaction records may be further relayed to a system of securities information service 20 for processing, and the processed results (alerts of buying/selling times) are displayed on the user terminal 13 for users to view and refer to. The users may also input other contents like self-selected portfolios and self-selected formulated portfolios into the system of securities information service 20, so that the processed results may be tailored to meet the users' personal requirements; wherein contents of the self-selected formulated portfolios include: parameters and formulas of each reference price as defined by the users, items and contents of the combined data that are displayed as defined by the users.

In this preferred embodiment, the user terminal 13 may be an electronic device that allows users to use and operate, and particularly referring to a handheld wireless communication device that may receive and process securities information via wireless communication, the handheld wireless communication device may be one of the following but not limited to: smart phones, handheld stock managers, or PDAs with mobile communication, which may connect and transmit data to a source of securities information 11 and a brokerage firm 12 via mobile communication networks like GPRS (General Packet Radio Service) and 3 G. In this invention, the system of securities information service 20 is preferably presented as a software that is directly built in the user terminal 13. However, the system of securities information service 20 may also be an independent electronic device that may connect to the user terminal 13 via wires or wirelessly.

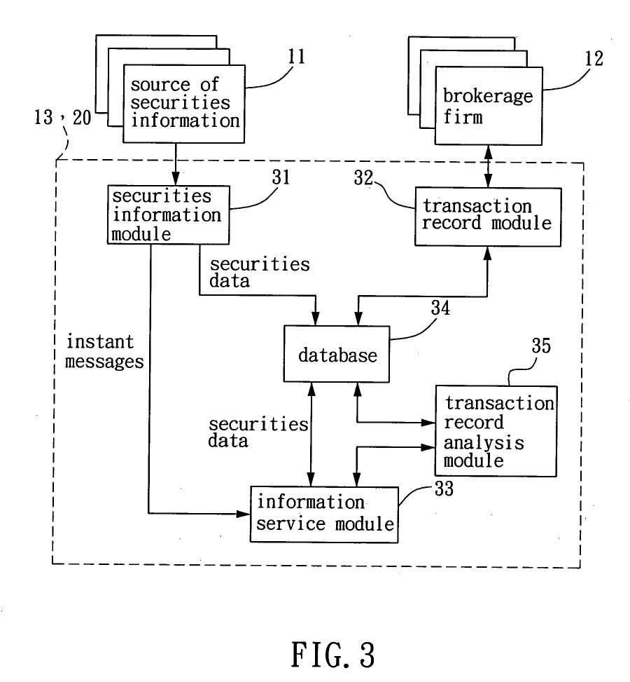

Referring to FIG. 3, which is a schematic view that shows a structure of a system of securities information service according to a preferred embodiment of the invention. The system of securities information service 20 of the invention is built in an environment of electronic transaction basing on a communication network system (including but not limited to: GSM, CDMA, GPRS, 3 G, DVB, and DAB), and may receive securities information from the source of securities information 11 (may be financial and securities services such as security exchanges, securities markets, and futures exchanges) via the communication network system. Since securities information of different attributes may be provided by different sources of securities information 11, the sources of securities information 11 are not limited to a single financial and securities service provider. In addition to receiving securities information, the system of securities information service 20 may also receive transaction records provided by the brokerage firms 12 via the communication network system. Because the transaction records may be completed at different brokerage firms, the brokerage firms 12 are not limited to a single organization.

In this preferred embodiment, the system of securities information service 20 comprises: a securities information module 31, a transaction record module 32, an information service module 33, a database 34, and a transaction record analysis module 35. The securities information module 31 receives all of the securities information from the external sources of securities information 11; wherein the securities information includes securities data or instant messages of each security. The instant messages may include instant transaction data or instant news of each security. The securities data may include technical indicators of each security, basic information of each security, and financial reports of each security. Subsequently, the securities information module 31 directly transmits the instant messages to the information service module 33, and the securities data is stored in the database 34. The transaction record module 32 may receive transaction records of all of the users from the external brokerage firms 12; wherein the transaction records are related to portfolios and investment costs of each of the users, which are stocks held by each user and tradable at a brokerage firm 12, as well as numbers and costs of such stocks. The transaction records may further include volumes and prices of securities transactions that have been undertaken by each user. Afterwards, the transaction record module 32 directly stores the transaction records of all of the users in the database 34. Because users of each brokerage firm are not limited to the users registered under the system of securities information service 20, and securities that have been traded by each user in the past will not necessarily appear in the latest securities list for reference, the transaction record module 32 of the embodiment may inquire about and receive relevant transaction records from different brokerage firms 12 according to a transaction record inquiry sent by the information service module 33. Therefore, the system does not need to receive all of the transaction records from the brokerage firms 12 without filtration, thus effectively reducing system load thereof. The information service module 33 may receive a user option inputted by an external user; wherein the user option may include self-selected portfolios and self-selected formulated portfolios, and contents of the self-selected formulated portfolios include: parameters and formulas of each reference price as defined by the users, items and contents of the combined data that are displayed as defined by the users.

The information service module 33 may send a request of securities data inquiry to the database 34 according to names of securities appeared in the user option, and the database 34 will send back relevant securities data. The information service module 33 also receives instant messages sent from the securities information module 31. The securities information module 33 further sends a request of transaction record inquiry to the transaction record analysis module 35 according to the parameters and the formulas defined in the user option, and then the transaction record analysis module 35 searches for relevant transaction records in the database 34, and sends compiled figures back to the securities information module 33. After receiving the compiled figures, relevant instant messages, and securities data, the securities information module 33 compiles a combined data according to the items and the contents of the combined data as defined in the user option, and displays the combined data for the user to view and refer to, so that the user may simultaneously view all of the contents of the combined data. Meanwhile, the securities information module 33 may create comparison conditions according to figures of each of the parameters in the combined data; wherein the comparison conditions may employ figures of at least one of following parameters for comparison: a suggested purchasing price, a suggested selling price, a cost-price of purchase, PE10 (Price as 10 times of Earning), PE20 (Price as 20 times of Earning), 52-week Low (a lowest price for last 52 weeks), and 52-week High (a highest price for last 52 weeks). When the information service module 33 finds out that a market price in an instant message exceeds a recommended selling price or falls to a recommended buying price, the information service module 33 sends an alerting signal to the user. The alerting signal may be presented in various ways; for instance, the alerting signal may be presented as sounds at the user terminal 13, or as an alerting window displayed on a screen of the user terminal 13; and the securities displayed on the screen may be listed in different colors in order to remind users of buying/selling the security. The users may define a variety of combinations for the comparison conditions; for example, the recommended buying price may be defined as a comparison condition for buying; whereas the PE20 and the recommended selling price may be defined as comparison conditions for selling; wherein when the market price exceeds either the PE20 or the recommended selling price, the information module service 33 generates an alerting signal at the user terminal 13. An example is provided below, in which items and contents of the combined data that are displayed at the user terminal 13 as defined in the user option are shown:

| | | | | EPS | EPS | | | | | | |
|---|---|---|---|---|---|---|---|---|---|---|---|
| | | | | of | of | | | | | | |
| | | | Market | Last | This | | | 52-week | 52-week | Buying | Selling |
| Name | Quantity | Cost | Price | Year | Year | PE10 | PE20 | Low | High | Point | Point |
| TSMC | 1250 | 55.5 | 68.0 | 4.93 | 4.75 | 47.5 | 95 | 55.0 | 87.5 | Formula | Formula |

Wherein, this particular user has defined the item “Cost” at the user terminal 13, thus the information service module 33 sends a request of transaction record inquiry to the transaction record analysis module 35; if the transaction record analysis module 35 failed to locate corresponding transaction records for the user in the database 34, a notice would be sent to the transaction record module 32 so as to collect relevant transaction records from the brokerage firm 12. The information service module 33 also sends a request of securities data inquiry to the database 34, so as to demand the database 34 to send back relevant securities data. Finally, the information service module 33 calculates actual carrying charges for the user according to the portfolios and the investment costs in a user's transaction records, as well as the data of After-Hours Ex Warrant/Ex Divide obtained from the securities data. On the other hand, the recommended buying/selling price is generated after the information service module 33 searches for and compiles relevant securities data and transaction records according to the parameters and the formulas defined by the user in the user option. Of course, the user may also directly input a self-selected price instead of using the parameters and the formulas.

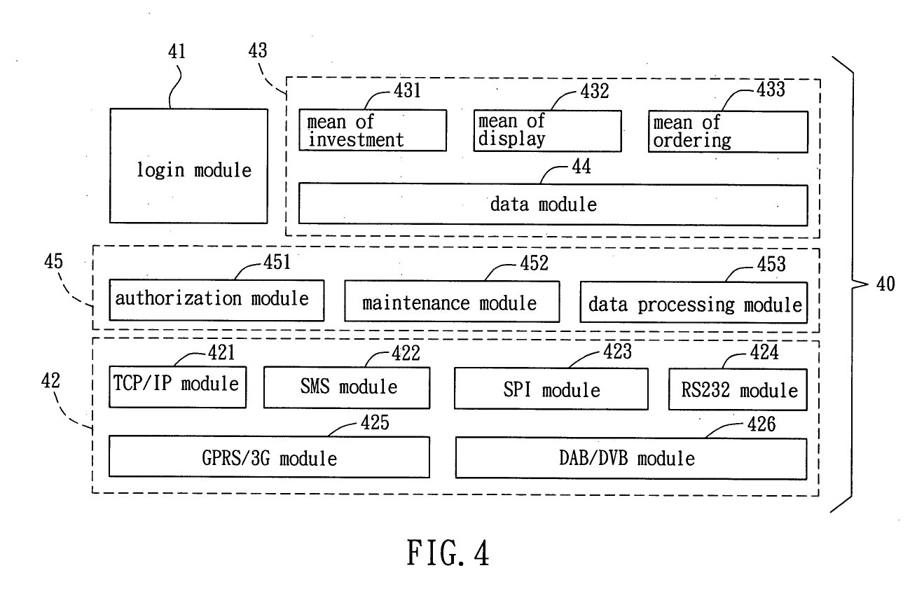

Referring to FIG. 4, which is a block view that shows devices of user terminals according to a preferred embodiment of the invention, wherein a device of user terminal 40 comprises: a login module 41, a connecting module 42, an application interface 43, a data module 44, and a core engine 45. When the device of user terminal 40 is communicating with the sources of securities information 11 (or brokerage firms 12) shown in FIG. 3, the core engine 45 may send an authorization to the sources of securities information 11 (or brokerage firms 12). Subsequently, when the sources of securities information 11 (or brokerage firms 12) is verifying the authorization, the device of user terminal 40 may communicate with and transmit data to the sources of securities information 11 (or brokerage firms 12); wherein the aforesaid alerting signal and the combined data may be displayed on a mean of display 432 of the device of user terminal 40.

The login module 41 may establish communications between the device of user terminal 40 and the sources of securities information 11 (or brokerage firms 12), and assist the users to log into the sources of securities information 11 (or brokerage firms 12).

The connecting module 42 communicates with the external sources of securities information 11 (or brokerage firms 12) via supported communication protocols. The communication protocols that may be used in the invention include but not limited to: GSM, GPRS, 3 G, DAB, and DVB. In this preferred embodiment, the connecting module 42 of the device of user terminal 40 further comprises: a TCP/IP module 421 for being integrated with the GPRS and the 3 G for carrying out communications, a SMS module 422 for providing the Short Message Service, a SPI (Serial Peripheral Interface) module 423 for providing connections to peripheral interfaces, a RS232 module 424 for providing connection to the RS232 interface, a GPRS/3G module 425 for carrying out communications via the GPRS and the 3G communication protocols, and a DAB/DVB module 426 for carrying out communications via the DAB/DVB communication protocols.

The application interface 43 may accept a command from a user and display characters and figures on the mean of display 432 according to the command. The application interface 43 further includes: a mean of investment 431, a mean of display 432, and a mean of investment 433. The mean of investment 431 allows users to select between self-selected portfolios and self-selected formulated portfolios, as well as defining parameters and formulas of each reference price, and deciding items and contents of the combined data that are displayed. The mean of display 432 may be a TFT LCD, a STN LCD, a plasma display, a projector, and a monitor. The mean of ordering 433 allows users to buy or sell securities like stocks, stock options, or futures via the mean of ordering 433.

The data module 44 is connected to the core engine 45 in order to store data transmitted from the core engine 45, and accepts inquiries from other components of the system.

The core engine 45 may interact with the application interface 43 and the sources of securities information 11 (or brokerage firms 12), as well as processing data from the connecting module 42, and processing commands inputted into the application interface 43. In this preferred embodiment, the core engine 45 further includes: an authorization module 451, a maintenance module 452, and a data processing module 453. The authorization module 451 may generate and transmit an authorization data to the sources of securities information 11 (or brokerage firms 12) when a user attempts to log into the sources of securities information 11 (or brokerage firms 12). The maintenance module 452 may maintain a connection between the device of user terminal 40 and the sources of securities information 11 (or brokerage firms 12), even if the user has not been operating the device for a while, or if data transmission has been temporarily interrupted because of natural causes or fluctuations in communication environments. The data processing module 453 is mainly used to process the alerting signals and the combined data received by the connecting module 42 from the sources of securities information 11 (or brokerage firms 12).

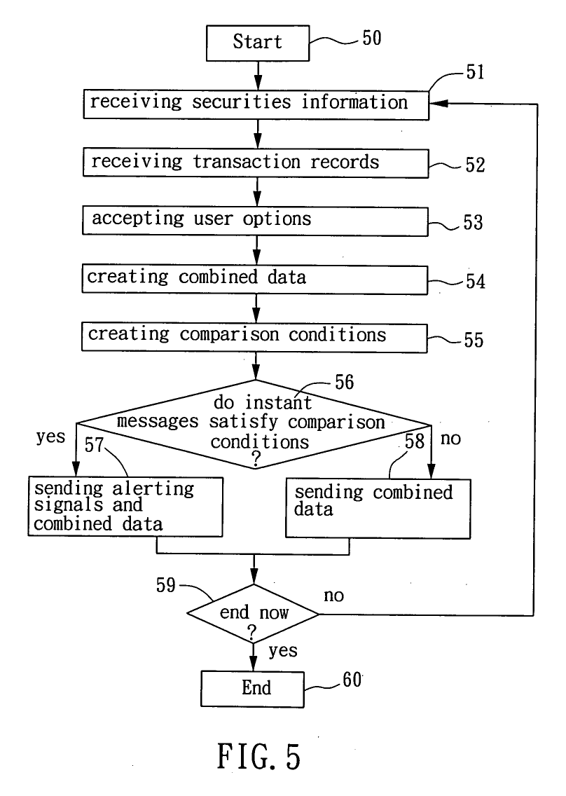

Referring to FIG. 5, which is a flow chart that shows a method for securities information service according to a preferred embodiment of the invention; comprising:

Step 50: starting the securities information service.

Step 51: receiving a plurality of securities information from external sources of securities information.

Step 52: receiving a plurality of transaction records provided by external brokerage firms.

Step 53: accepting a user option provided by an external user.

Step 54: compiling a combined data from the plurality of securities information and transaction records according to the user option.

Step 55: creating at least a comparison condition according to the combined data.

Step 56: checking if any instant messages meet the comparison condition; if “no”, the step 58 is executed; if “yes”, the step 57 is executed.

Step 57: sending an alerting signal and the combined data to the user, so that all contents of the combined data and the alerting signal may be simultaneously displayed to the user.

Step 58: sending an alerting signal to the user, so as to allow the user to simultaneously view all contents of the combined data.

Step 59: the user may decide whether to manually end the securities information service; if “no”, the step 51 is executed again; if “yes”, the step 60 is executed.

Step 60: ending the securities information service.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system of securities information service, comprising:
a securities information module for receiving a plurality of securities information from at least an external source of securities information;
a transaction record module for receiving a plurality of transaction records provided by at least an external brokerage firm; and
an information service module for accepting at least one user option provided by an external user, subsequently compiling a combined data from the plurality of securities information and transaction records according to the user option, as well as simultaneously displaying all contents of the combined data to the user.

2. The system of securities information service of claim 1, wherein the securities information may be selected from the group consisting of instant messages and securities data; the securities data includes at least one of following: technical indicators, basic information of companies, and financial reports; the transaction record at least includes: volumes of securities transactions and prices of securities transactions; while the user option at least includes: self-selected portfolios and self-selected formulated portfolios.

3. The system of securities information service of claim 1, further comprising:
a database for storing the plurality of securities data received via the securities information module, as well as the plurality of transaction records received via the transaction record module, and for accepting a securities data inquiry from the information service module.

4. The system of securities information service of claim 3, further comprising:
a transaction record analysis module located between the information service module and the database, for accepting a transaction record inquiry from the information service module, as well as retrieving and compiling relevant information from the database according to the transaction record inquiry.

5. The system of securities information service of claim 2, wherein the information service module creates at least one comparison condition according to the combined data, in which when contents of the instant messages satisfy the at least one comparison condition, the information service module sends an alerting signal to the user.

6. The system of securities information service of claim 5, wherein the comparison condition may be selected from the group consisting of: a suggested purchasing price, a suggested selling price, a cost-price of purchase, PE10 (Price as 10 times of Earning), PE20 (Price as 20 times of Earning), 52-week Low (a lowest price for last 52 weeks), and 52-week High (a highest price for last 52 weeks).

7. The system of securities information service of claim 1, wherein a terminal device used by the user further comprises:
a login module for assisting the user to log into the external sources of securities information and brokerage firms;
a connecting module for connecting to the sources of securities information and brokerage firms, and carrying out communications via a communication protocol supported by the sources of securities information and brokerage firms; wherein the connecting module may use at least one of following communication protocols for carrying out communications: GSM, GPRS, 3 G, DAB, and DVB; the connecting module further comprises: a TCP/IP module, a SMS (Short Message Service) module, a SPI (Serial Peripheral Interface) module, and a RS232 module;
an application interface for accepting a command from the user and executing an application according to the command; the application interface further comprises: a mean of investment, a mean of display, a mean of ordering;
a data module for storing a plurality of data received by the terminal device of the user; wherein the plurality of data includes at least one of following: instant messages, technical analysis, basic information of companies, and information of self-selected portfolios; and
a core engine for interacting with the application interface, the sources of securities information, and the brokerage firms, processing data from the connecting module, and processing commands from the application interface; the core engine further comprises: an authorization module, a maintenance module, and a data processing module.

8. A system of securities information service, comprising:
a securities information module for receiving a plurality of securities information from at least an external source of securities information;
a transaction record module for receiving a plurality of transaction records provided by at least an external brokerage firm; and
an information service module for accepting at least one user option provided by an external user, subsequently establishing a recommended buying price and a recommended selling price for a plurality of securities included in the user option, respectively, according to the user option, the plurality of securities information and transaction records; wherein when contents of instant messages satisfy the at least one recommend price, the information service module sends an alerting signal to the user.

9. The system of securities information service of claim 8, wherein the securities information may be selected from the group consisting of instant messages and securities data; the securities data includes at least one of following: technical indicators, basic information of companies, and financial reports; the transaction record at least includes: volumes of securities transactions and prices of securities transactions; while the user option at least includes: self-selected portfolios and self-selected formulated portfolios.

10. The system of securities information service of claim 9, wherein the information service module searches for at least one of following relevant information according to the self-selected portfolios and self-selected formulated portfolios in the user option: technical indicators, basic information of companies, financial reports, volumes and prices of securities transactions, thereby establishing the recommended buying price and the recommended selling price.

11. The system of securities information service of claim 8, further comprising:
a database for storing the plurality of securities data received via the securities information module, as well as the plurality of transaction records received via the transaction record module, and for accepting a securities data inquiry from the information service module.

12. The system of securities information service of claim 8, further comprising:
a transaction record analysis module located between the information service module and the database, for accepting a transaction record inquiry from the information service module, as well as retrieving and compiling relevant information from the database according to the transaction record inquiry.

13. The system of securities information service of claim 8, wherein a terminal device used by the user further comprises:
a login module for assisting the user to log into the external sources of securities information and brokerage firms;
a connecting module for connecting to the sources of securities information and brokerage firms, and carrying out communications via a communication protocol supported by the sources of securities information and brokerage firms; wherein the connecting module may use at least one of following communication protocols for carrying out communications: GSM, GPRS, 3 G, DAB, and DVB; the connecting module further comprises: a TCP/IP module, a SMS (Short Message Service) module, a SPI (Serial Peripheral Interface) module, and a RS232 module;
an application interface for accepting a command from the user and executing an application according to the command; the application interface further comprises: a mean of investment, a mean of display, a mean of ordering;
a data module for storing a plurality of data received by the terminal device of the user; wherein the plurality of data includes at least one of following: instant messages, technical analysis, basic information of companies, and information of self-selected portfolios; and
a core engine for interacting with the application interface, the sources of securities information, and the brokerage firms, processing data from the connecting module, and processing commands from the application interface; the core engine further comprises: an authorization module, a maintenance module, and a data processing module.

14. A method for securities information service, comprising:
receiving a plurality of securities information from at least an external source of securities information;
receiving a plurality of transaction records provided by at least an external brokerage firm; and
accepting at least one user option provided by an external user, subsequently compiling a combined data from the plurality of securities information and transaction records according to the user option, as well as simultaneously displaying all contents of the combined data to the user.

15. The method for securities information service of claim 14, wherein the securities information may be selected from the group consisting of instant messages and securities data; the securities data includes at least one of following: technical indicators, basic information of companies, and financial reports; the transaction record at least includes: volumes of securities transactions and prices of securities transactions; while the user option at least includes: self-selected portfolios and self-selected formulated portfolios.

16. The method for securities information service of claim 15, further comprising:
creating at least one comparison condition according to the combined data, and accepting at least an instant message from the source of securities information; wherein when contents of the instant message satisfies the at least one comparison condition, the information service module sends an alerting signal to the user.

17. The method for securities information service of claim 16, wherein the comparison condition may be selected from the group consisting of: a suggested purchasing price, a suggested selling price, a cost-price of purchase, PE10 (Price as 10 times of Earning), PE20 (Price as 20 times of Earning), 52-week Low (a lowest price for last 52 weeks), and 52-week High (a highest price for last 52 weeks).

18. The method for securities information service of claim 17, wherein at least one of following relevant information is looked up according to a self-selected portfolio and a self-selected formulated portfolio included in the user option: technical indicators, basic information of companies, financial reports, volumes and prices of securities transactions, thereby creating the comparison condition.
